(19) United States
(12) Patent Application Publication
(10) Pub. No.: US 2012/0187705 A1
(43) Pub. Date: Jul. 26, 2012

(54) Cotton Module Spear Implement

(75) Inventors: Byron Small, Senath, MO (US); Randy Branch, Baxley, GA (US)

(73) Assignees: R AND A BRANCH FARM, Baxley, GA (US); SMALL INC., Senath, MO (US)

(21) Appl. No.: 13/033,601

(22) Filed: Feb. 23, 2011

(51) Int. Cl. A01D 87/12; B66F 9/12

(52) U.S. Cl. 294/61

(57) ABSTRACT

A cotton module handling implement has a plurality of elongated tapered rods attached to a frame. Each rod extends perpendicular to the front face of the frame and is positioned horizontally and vertically so as to distribute the weight of the cotton module evenly across each rod and throughout the cotton module itself. The number and width of the rods allow for penetration of the cotton module without substantially disturbing the seed cotton integrity. Mounting brackets for either a three-point hitch or a front-end loader extend from the rear face of the frame.

### BACKGROUND OF THE INVENTION

Modern cotton harvesting techniques separate the fibrous cotton boll from the remainder of the plant. The bolls are formed into large generally cylindrical cotton modules then wrapped with plastic and placed in the field. These cotton modules may be 8 feet long, by 8 feet in diameter and have a weight of approximately 5,000 pounds. Generally, the modules are staged in rows in the field until later picked up and transportation to the cotton gin where the modules are unwrapped and the seed cotton is further cleaned and processed.

The size, weight and density of the cotton modules require equipment specifically designed for handling cotton modules in the field. Current hay bale handling equipment does not provide adequate support of the cotton module to prevent the cotton module from falling apart either upon insertion or removal of the rods, or upon lifting of the module. To address the more fluidic nature of the cotton modules, current cotton module handlers include devices that lift or cradle the module from the bottom, such as the John Deer CM11 series cotton module handlers, or devices that grapple the module. Both cotton module handling devices involve complex actuators and moving joints that unnecessarily increase the complexity and expense of cotton module handling. These handling devices also grasp the bale on the outer wrapping and can cause damage to the wrapping further complicating the handling process. Furthermore, both the cradle style and grappling style cotton module handlers pinch or grasp near the bottom of the module to support it. In doing so, undesired plant stalks, twigs and other trash is picked up with the module, requiring removal prior to further processing.

A need exists for a cotton module handler that is robust, possesses few if any moving parts, can penetrate and lift the cotton module without disintegration of the module, and minimizes or eliminates the need to remove stalks, twigs and other trash that otherwise would have been picked up in handling the cotton modules.

### BRIEF SUMMARY OF THE INVENTION

The cotton module handling implement has a plurality of elongated tapered rods attached to a frame. Each rod extends perpendicular to the front face of the frame and is positioned horizontally and vertically so as to distribute the weight of the cotton module evenly across each rod and throughout the cotton module itself. The number and width of the rods allow for penetration of the cotton module without substantially disturbing the seed cotton integrity. Mounting brackets for either a three-point hitch or a front-end loader extend from the rear face of the frame.

The present invention's simple construction results in a device that is robust, efficient, inexpensive to construct and inexpensive and simple to operate. Unlike the hydraulically powered grappling and lifting cotton bale handlers, the current invention possesses no hydraulically moving components that can break, wear out, or require maintenance. Furthermore, operation is 50% faster than other such cotton module movers. The device is capable of penetrating, elevating and transporting a cotton module without loss of module integrity of the cotton module and without introducing undesired plant stalks, twigs or other trash to the cotton module.

During use, the operator moves the invention, attached to a three-point hitch or front-end loader, such that the tapered rods penetrate one of the cotton module unwrapped surfaces. The module is then elevated and rotated a desired amount and transported to the desired location. It can then be lowered and the operator can move the invention, sliding the rods from the module without substantially disturbing the cotton module's structural integrity.

### BRIEF DESCRIPTION OF THE DRAWINGS

The invention is illustrated by the accompanying drawings, in which:

FIG. 1 is a front perspective view of a first embodiment of the invention attached to a three-point hitch.

FIG. 2 is a rear perspective view of the first embodiment of the invention showing the sleeved attachment of the rods to the frame and three point hitch attachment brackets.

FIG. 3 is a side view of the first embodiment of the invention.

FIG. 4 is a rear view of the first embodiment of the invention.

FIG. 5 is a cross-sectional view of the rod and frame connection of FIG. 4 taken at section line 5-5 in FIG. 4.

FIG. 6 is a top view of the first embodiment of the invention.

FIG. 7 is a front perspective view of a second embodiment of the invention attached to a front end loader.

FIG. 8 is a side view of the second embodiment of the invention.

FIG. 9 is a front view of the second embodiment of the invention.

FIG. 10 a cross-sectional view of the rod and frame connection of FIG. 9 taken at section line 10-10 in FIG. 9.

FIG. 11 is a top view of the second embodiment of the invention.

### DETAILED DESCRIPTION OF THE INVENTION

The drawings illustrate an invention that enables an individual to move a large cotton module by penetrating the module with, and supporting it upon, tapered rods spaced apart to distribute the bulk of the module's weight evenly throughout the module's volume. The invention enables cotton module handling in a manner that avoids picking up plant stalks, twigs or other trash associated with other forms of cotton module handlers.

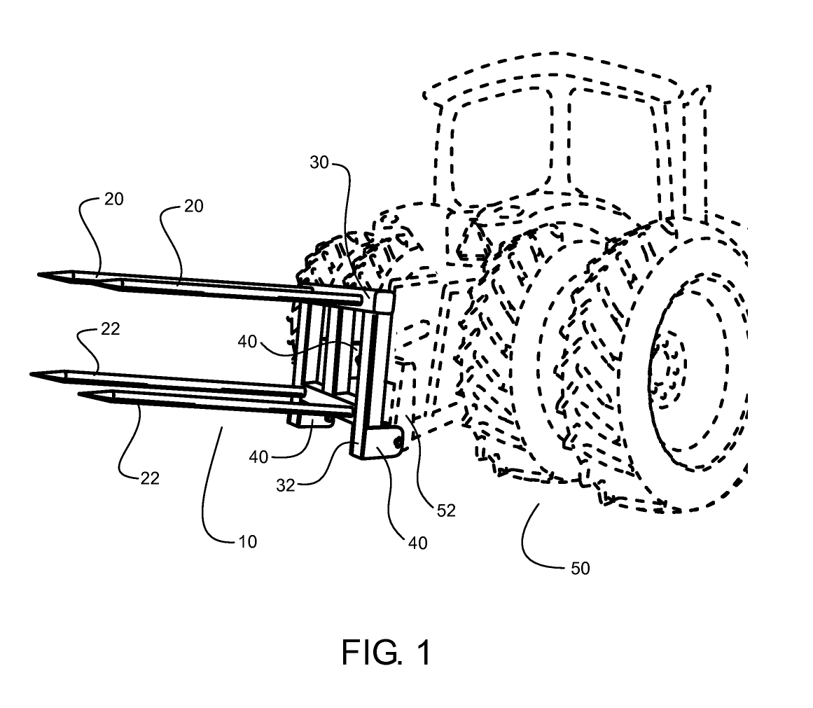

FIG. 1 shows a first embodiment of the present invention 10 designed for attachment to a three-point hitch 52 of a tractor 50. The invention includes a plurality of generally parallel rods 20 and 22, of sufficient length to penetrate 85 percent of the length of the cotton module, a frame 30, and three point hitch attachment brackets 40. Preferably, each rod 20, 22 is constructed of a high strength metal alloy. In the preferred version of the first embodiment, the invention possesses two upper rods 20 and two lower rods 22 arranged in a generally rectangular or trapezoidal pattern extending from the front face 32 of the frame.

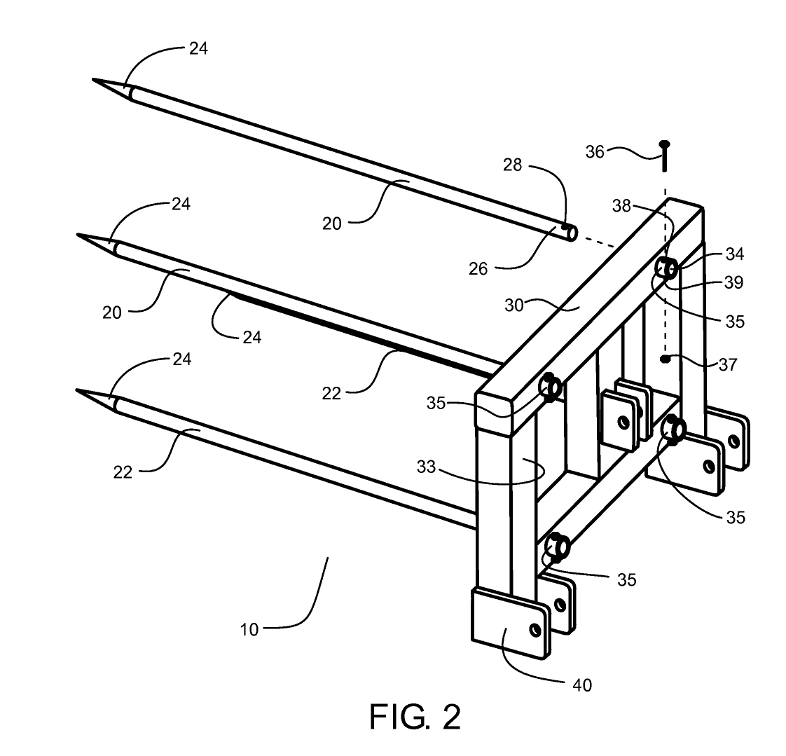

FIG. 2 shows a rear perspective view of the first embodiment of the present invention 10. Each rod, 20 or 22, possesses a tip portion 24 and a base portion 26. Preferably each rod is between 7 and 8 feet long, with each upper rod 20 having a slightly smaller diameter than each lower rod 22. Preferably each upper rod 20 has a diameter of approximately 2 inches, while each lower rod 22 possesses a diameter of approximately 2.25 inches. The tip portion 24 possesses a taper, preferably between 8 and 14 inches in length having a tip radius of approximately 0.125 to 0.25 inches. Apertures 34 within the frame 30 are of the appropriate diameter to receive each rod base portion 26. Preferably, for the first embodiment, the diameter of the aperture 34 allows for a non-interference fit between the inside surface of the aperture and the exterior surface of the mating surface of the rod 20, 22. The non-interference fit allows for some movement to aid in module penetration and allows for easier replacement, repair and storage of the rods and frame.

In the preferred version of the first embodiment of the present invention, each aperture 34 is contained within a sleeved portion 35, the sleeve portion 35 secured to the frame 30. Each rod 20 or 22 may be secured to the frame 30 by any means known in the art. In the preferred version of the first embodiment, each rod 20 or 22 is secured by a retaining pin or bolt 36 passing through a first sleeve hole 38, a hole in the rod 28 and a second sleeve hole 39, and secured with a nut 37.

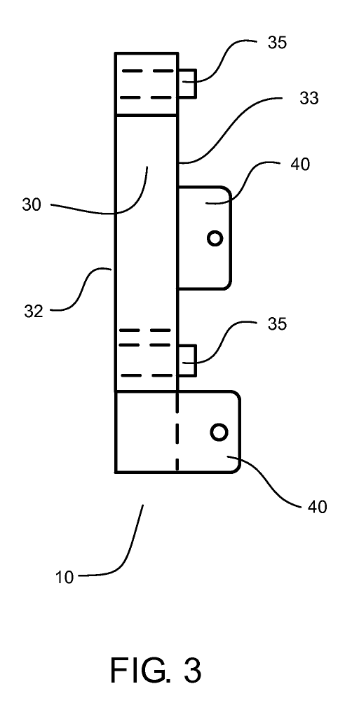

FIG. 3 shows a side view of the frame 30, three-point hitch mounting brackets 40, and rod sleeves 35. The sleeves 35 increase the overall strength of the frame 30 to rod assembly 20 or 22 and ease installation through the frame 30 which may be of hollow tubular construction. The sleeves 35 in the preferred version of the first embodiment of the invention 10 extend out past the back surface 33 of the frame. The sleeves however in this embodiment lay flush with the front surface 32 of the frame 30 to allow full penetration of the rods into the module up to the front surface 32 of the frame 30 without hindrance of the sleeve 35.

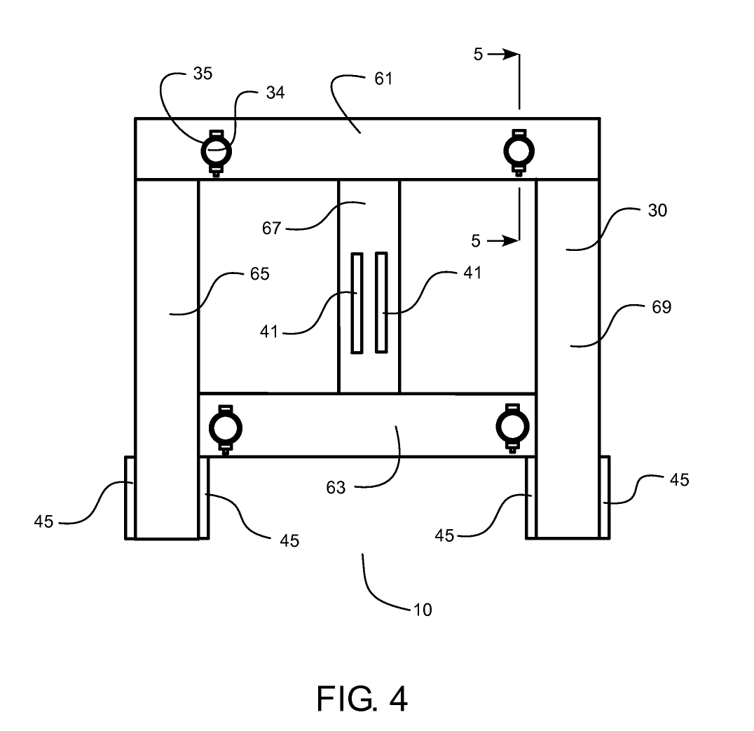

FIG. 4 shows a rear view of the frame 30 of the invention 10. The frame 30 in the preferred version of the first embodiment of the invention has a first top horizontal member 61; a second horizontal lower member 63; a left side member 65 connecting the first horizontal top member 61 and the second horizontal lower member 63; a center vertical member 67 connecting the first horizontal top member 61, and the second horizontal lower member 63; and a right side member 69 connecting the first horizontal top member 61 and the second horizontal lower member 63. Two upper three-point hitch attachment brackets 41 attach to the center vertical member 67. Two lower left three-point hitch brackets 45 are attached to the left side vertical member 65 and two lower right three-point hitch brackets 45 are attached to the right side vertical member 69. The mounting brackets 40, 41, 45 are positioned lower on the frame 30 than the rods 20, 22 for additional ground clearance when the cotton module is elevated. In the preferred version of the first embodiment of the invention 10, the lower three-point hitch mounting brackets are attached to the portion of the right and left vertical members 65 and 69 that extend below the lower horizontal frame member 63. The sleeves 35 and associated apertures 34 are shown as being spaced apart in a generally trapezoidal pattern, with the upper sleeves 35 being slightly wider apart than the lower sleeves, both upper and lower sleeves 35 being spaced horizontally apart a greater distance than the distance they are spaced apart vertically. Spacing the rods 20 and 22 apart vertically and horizontally help to distribute the weight of the cotton module throughout the module boll matrix, preventing the module from falling apart or the rods from pulling out. The rods 20 and 22 are close enough together, however, not to lie near the outer surface of the cotton module. While this preferred version of the first preferred embodiment shows a trapezoidal pattern having the rods spaced a distance ranging from 27 to 30 inches, other patterns and dimensions within the scope of the invention may be utilized, including a rectangular pattern or a diamond pattern.

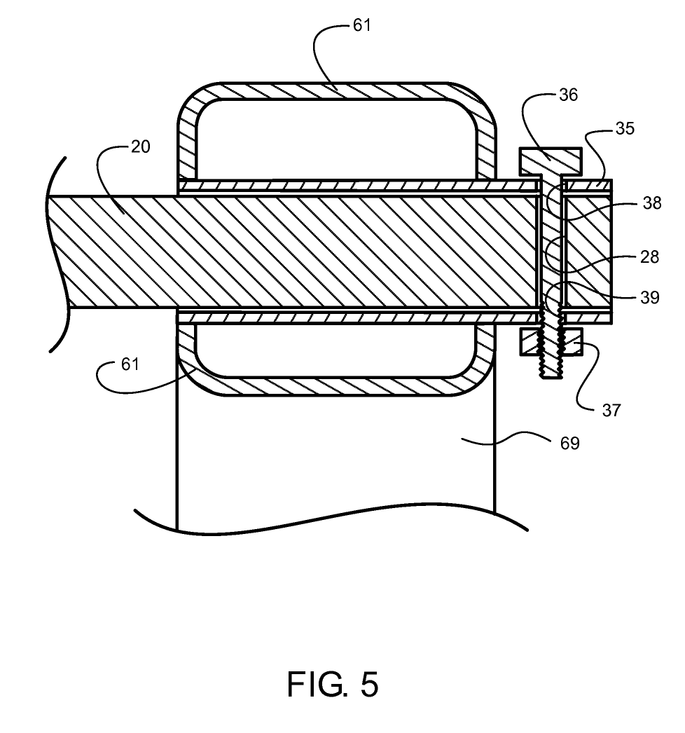

FIG. 5 shows a cross-sectional view of the rod and frame connection of FIG. 4 taken at section line 5-5 in FIG. 4. The rod 20 is shown having a width less than that of the sleeve 35 that it is inserted to. This non-interference fit allows for a slightly greater amount of movement of the rod during insertion and removal from the cotton module, reducing disturbance and aiding in penetration. Additionally, this non-interference fit allows for easier removal and insertion of the rod 20 into the sleeve 35, should replacement or repair be necessary. The sleeve 35 extends rearward past the upper frame member 61, but does not extend past the front face of the upper frame member 61. The rod 20 of the first preferred embodiment is shown to be secured by a bolt 36 that is inserted through an upper hole 38 of the sleeve 35, through a hole 28 in the rod 20, and through a lower hole 39 of the sleeve 35. Here, the bolt 36 is shown secured by a nut 37. It should be understood, however, that the rod may be secured to the sleeve by any mean known in the art, including using retaining pins, bolts or retaining clips.

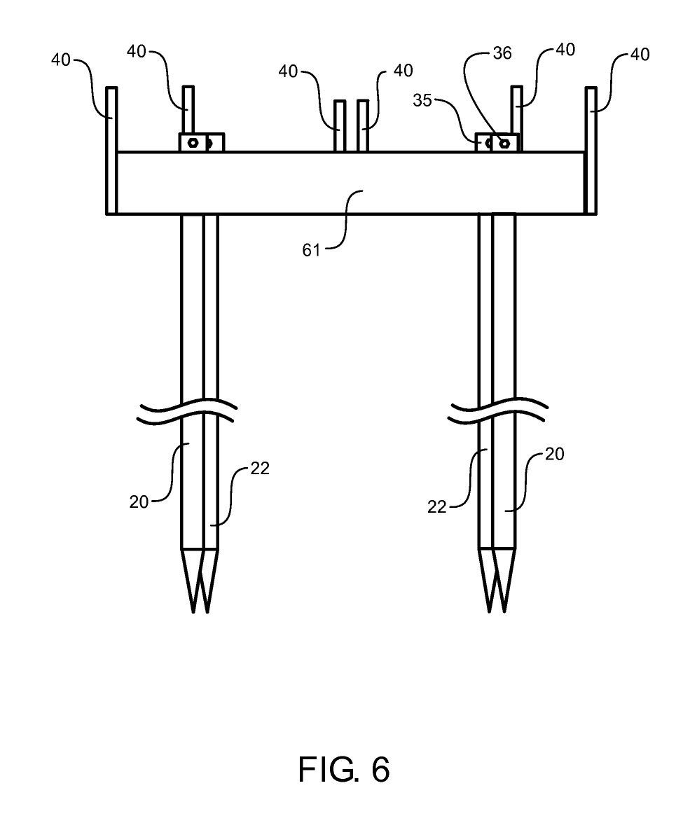

FIG. 6 shows a top view of the invention 10. The rods 20, 22 extend from the front surface 32 of the frame 30. The three point hitch mounting brackets 40 and sleeves 35 extend from the rear surface 33 of the frame 30.

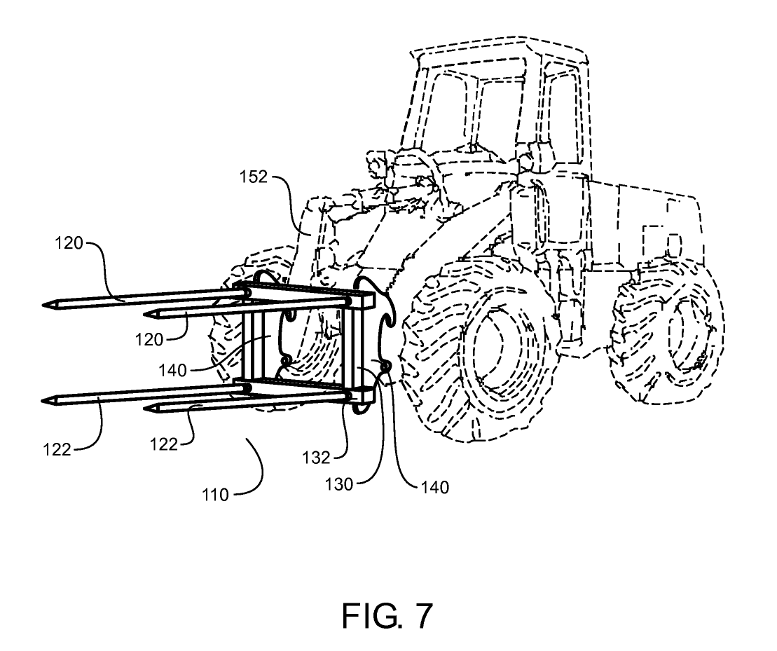

FIG. 7 shows a second embodiment of the present invention 110 designed for attachment to a front end loader 152. Like the first embodiment the invention includes a plurality of generally parallel rods 120, 122, a frame 130, and front-end loader attachment brackets 140. The rods 120 and 122 are of sufficient length to penetrate at least 65 percent of the length of the cotton module. In the preferred version of this second embodiment, the invention possesses two upper rods 120 and two lower rods 122 arranged in a square pattern extending from the front face 132 of the frame. Preferably, the rods 120, 122 are spaced apart approximately 36 inches on each center.

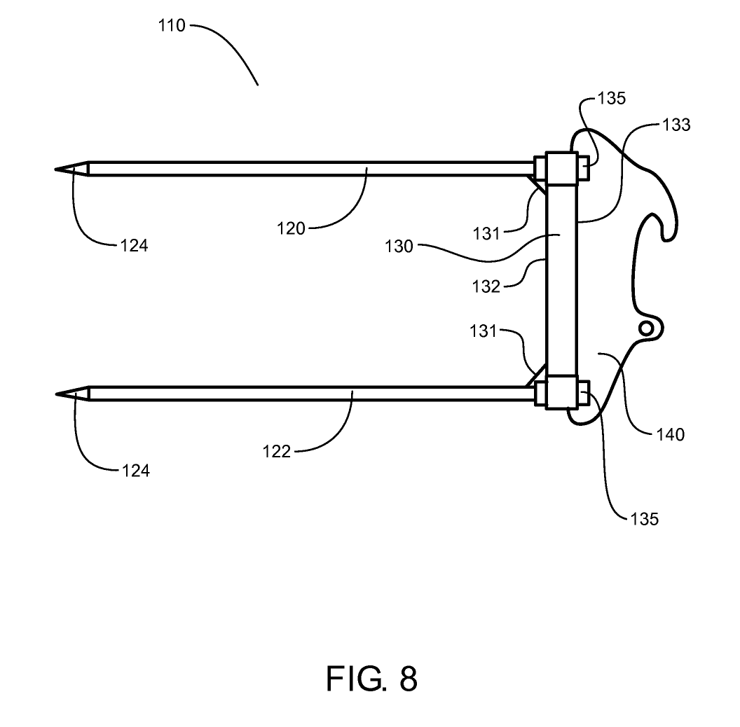

FIG. 8 shows a side view of the frame 130, front-end loader mounting brackets 140, and rod sleeves 135. The sleeves 135 increase the overall strength of the frame 130 to rod 120, 122 assembly and ease installation through the frame 130 which may be of hollow tubular construction. The sleeves 135 in the preferred version of the second embodiment of the invention 110 extend out past the back surface 133 of the frame 130 and extend past the front surface 132 of the frame 130. Preferably each upper and lower rod 120 and 122 has a diameter of approximately 2½ inches. The tip portion 124 possesses a taper, preferably between 8 and 14 inches in length and more preferably 12 inches in length, having a tip radius preferably 0.062 to 0.125 inches and more preferably 0.187 inches. A web 131 attaches to and reinforces the sleeve 135 and frame 130 assembly.

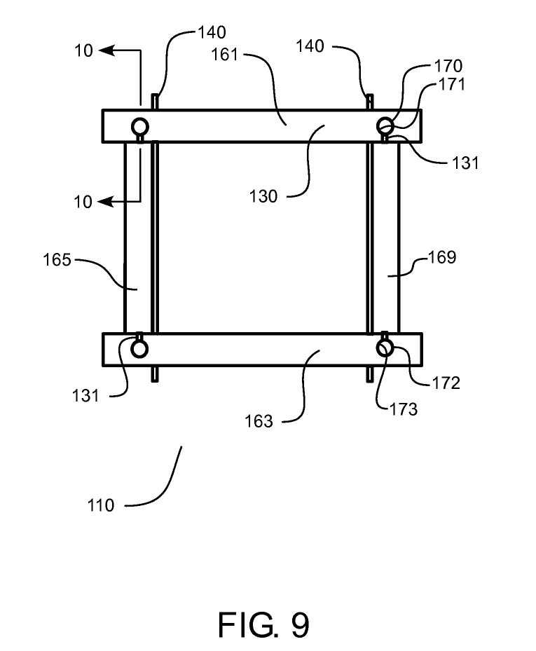

FIG. 9 shows a front view of the frame 130 of the invention 110. The frame 130 in the preferred version of the second embodiment of the invention has a first top horizontal member 161; a second horizontal lower member 163; a left side member 165 connecting the first horizontal top member 161 and the second horizontal lower member 163; and a right side member 169 connecting the first horizontal top member 161 and the second horizontal lower member 163. Two front-end loader attachment brackets 140 attach to the right and left side members 165 and 169. The sleeves 170 and 172 and associated apertures 171 and 173 are shown as being spaced apart in a generally square pattern, with the upper sleeves 170 spaced apart an equal distance as the lower sleeves 172, both upper and lower sleeves 170, 172 being spaced apart vertically the same as they are horizontally. Spacing the rods 120 and 122 apart vertically and horizontally helps to distribute the weight of the cotton module throughout the module boll matrix, preventing the module from falling apart or the rods from pulling out. While this preferred version of the second preferred embodiment shows a square pattern having the rods 120 and 122 horizontally and vertically spaced approximately 36 inches apart, other patterns and dimensions within the scope of the invention may be utilized, including a trapezoidal, rectangular, or a diamond pattern. Apertures 171 and 173 within the frame 130 are of the appropriate diameter to receive each rod.

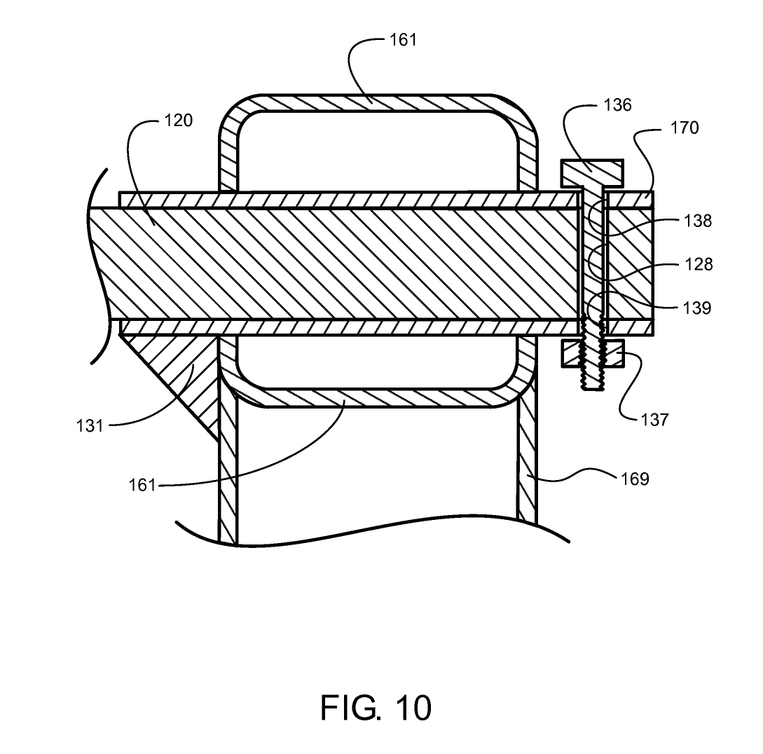

FIG. 10 shows a cross-sectional view of the rod and frame connection of FIG. 9 taken at section line 10-10 in FIG. 9. Here, for the second embodiment, the diameter of the rod 120 and interior diameter of the sleeve 170 create an interference fit between the inside surface of the aperture and the exterior mating surface of the rod 120. The interference fit provides greater rigidity in the relatively shorter tines of the second embodiment while still allowing for replacement or repair of a rod 120 or 122. The rod 120 is shown here secured to the upper frame member 161 by a bolt 136 passing though a through an upper bore 138 in the sleeve 170, through a bore 128 in the rod 120, and through a lower bore 139 of the sleeve. The bolt 136 is secured with a nut 137. It should be understood, however, that the rod may be secured to the sleeve by any mean known in the art, including using retaining pins, bolts or retaining clips.

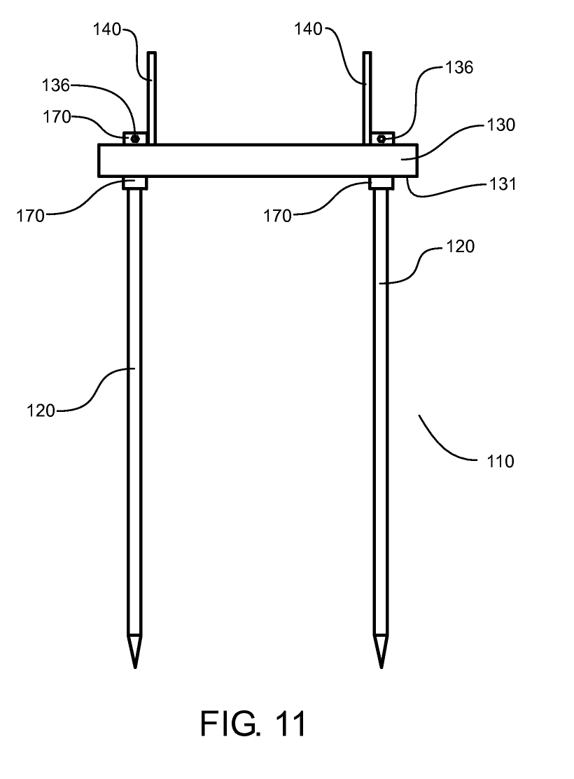

FIG. 11 shows a top view of the invention 110. The rods 120, 122 and sleeves 170, 172 extend from the front surface 132 of the frame 130. The front-end loader mounting brackets 140 and sleeves 170, 172 extend from the rear surface 133 of the frame 130. Each rod 120, 122 is secured to the frame 130 with a pin or bolt 136 passing through the sleeve 170, 172 and into the rod 120, 122.

To operate the cotton module handling attachment, the invention is attached to a three-point hitch, front end loader or the like. The operator then positions the invention 10 or 110 such that the tapered rod tips 24, 124 point at the generally circular unwrapped portion of the cotton module. The operator then moves the invention 10, or 110 toward the cotton module penetrating the seed cotton matrix until the frame is resting against the cotton module. The operator tilts and or lifts the cotton module, elevating it and rotating it from its resting position. The module then can be transported to the desired location, lowered, and the invention can then be removed from the cotton module.

The operation for the invention attached to the three-point hitch varies slightly from the operation of the invention on the front end loader, in that upon penetrating the module, the user may set the hydraulic system of the three point hitch to a float mode, allowing the invention to move slightly as it penetrates the cotton module. The module is then elevated with a slight angle towards the back of the invention.

When the invention 110 is attached to a front-end loader or the like, upon or after elevating the cotton module, the operator generally rotates the cotton module at a greater angle toward the rear of the invention 110, allowing more weight to bear against the frame 130 of the invention 110.

What is claimed is:

1: A cotton module handling apparatus capable of penetrating, elevating and transporting a cotton module, said apparatus comprising:
a frame having a front side and a back side,
at least four parallel elongated rods of generally substantially equal length, each rod secured to and extending outwardly from said front side of said frame;
wherein said rods are spaced apart horizontally and vertically along said front face of said frame so as to distribute the weight of said cotton module evenly across each said rod and throughout said cotton module when said rods are inserted into and support said cotton module.

2: The device of claim 1 further comprising a plurality of attachment brackets for mounting to a vehicle, a plurality of said attachment brackets positioned lower than said rods on said frame.

3: The device of claim 1 wherein each said rod possesses a tapered tip.

4: The device of claim 1, wherein the length of each said rod from said frame to the tip of said rod is between 5 feet and 8 feet and each rod possesses a width between 2 inches and 3 inches.

5: The device of claim 1 wherein the length of each said rod from said frame to the tip of said rod is between 5 feet 6 inches and 5 feet 8 inches and possesses a width of approximately 2½ inches.

6: The device of claim 4 wherein said frame is adapted to attach to a front end loader.

7: The device of claim 1, wherein the length of each said rod from said frame to the tip of said rod is between 7 feet and 8 feet long and possesses a width between 2 inches and 3 inches.

8: The device of claim 1 wherein the length of each said rod from said frame to the tip of said rod is between 7 feet 4 inches and 7 feet 8 inches and possesses a width between 2 inches and 2½ inches.

9: The device of claim 7 wherein said frame is adapted to attach to a three point hitch.

10: A cotton module handling apparatus capable of penetrating, elevating and transporting a cotton module, said apparatus comprising:
a frame having a front side and a back side,
four parallel elongated rods of generally substantially equal length, each rod having a base portion and a tip portion; said base of each rod being secured to said frame, said rod extending forward from said front side of said frame,
wherein said rods are spaced apart horizontally and vertically along said front face of said frame so as to distribute the weight of said cotton module evenly across each said rod and throughout said cotton module.

11: The device of claim 10 wherein each said rod tip portion is tapered.

12: The device of claim 11 wherein said tapered tip portion is between 8 and 14 inches long.

13: The device of claim 10, wherein the length of each said rod from said frame to the tip of said rod is between 5 feet and 8 feet and possesses a width between 2 inches and 3 inches.

14: The device of claim 13 wherein said frame is adapted to attach to a front end loader.

15: The device of claim 14 wherein said frame possesses a plurality of sleeved apertures into which each said rod base is received, each said aperture sized to provide an interference fit, said rod being secured to said sleeve.

16: The device of claim 16 wherein said frame is adapted to attach to a three point hitch.

17: The device of claim 16 wherein said frame possesses a plurality of sleeved apertures into which each said rod base is received, each said aperture of sufficient dimensions to provide non-interference fit, said rod secured to said sleeve.

18: The device of claim 10, wherein the length of each said rod from said frame to the tip of said rod is between 7 feet and 8 feet long and possesses a width between 2 inches and 3 inches.

19: The device of claim 10 wherein the length of each said rod from said frame to the tip of said rod is between 7 feet 4 inches and 7 feet 8 inches and possesses a width between 2 inches and 2½ inches.

20: The device of claim 10 wherein the length of each said rod from said frame to the tip of said rod is between 5 feet 6 inches and 5 feet 8 inches and possesses a width of approximately 2½ inches.

21: The device of claim 10 wherein each said rod base is attached to said frame forming a trapezoidal pattern, two of said rods attached at the top portion of said frame, and two of said rods attached at the bottom of said frame.

22: The device of claim 21 wherein said rods attached at the top of said frame are of a smaller diameter than said rods attached at the bottom of said frame.

22: A cotton module handling apparatus capable of penetrating, elevating and transporting a cotton module, said apparatus comprising:
a frame having a front side and a back side,
four parallel elongated rods of generally substantially equal length sufficient to penetrate at least 70 percent of the length of said cotton module, each rod having a base portion and a tip portion;
said frame having four sleeved apertures for receiving said rod base portion, said rod secured to said sleeve, said rod extending out from said front side of said frame;
wherein said rods are spaced apart horizontally and vertically along said front face of said frame, two of said rods being attached at the top portion of said frame, and two of said rods being attached at the bottom of said frame.

23: A method of penetrating, elevating and transporting a cotton module from a first location to a second location, said method comprises:
penetrating said cotton module, said cotton module located at said first location, with at least four parallel elongated rods of generally substantially equal length, each rod secured to and extending outwardly from a front side of a frame;
elevating said frame, rods and cotton module, wherein said rods are spaced apart horizontally and vertically along said front side of said frame so as to distribute the weight of said cotton module evenly across each said rod and throughout said cotton module when said rods are inserted into and support said cotton module,
transporting said cotton module to said second location.
